(19) United States
(12) Patent Application Publication
(10) Pub. No.: US 2025/0245763 A1
(43) Pub. Date: Jul. 31, 2025

(54) DIGITAL ESTATE PLANNING SYSTEM

(71) Applicant: Wells Fargo Bank, N.A., San Francisco, CA (US)

(72) Inventors: Brian M. McMillen, Davidson, NC (US); Aaron L. Johnson, Charlotte, NC (US); Gurudatta Pai, Matthews, NC (US); Tambra Nichols, Charlotte, NC (US); Carrie Anne Hanson, Charlotte, NC (US)

(21) Appl. No.: 18/049,789

(22) Filed: Oct. 26, 2022

(51) Int. Cl. G06Q 50/18

(52) U.S. Cl. CPC G06Q 50/186

(57) ABSTRACT

Various systems and methods for providing a digital estate plan system are described herein. An online system for managing beneficiaries and assets of a will is configured to access transaction data related to a user; identify a person or a property based on the transaction data; present a confirmation request to the user to confirm that the person is a beneficiary of the will or that the property is an asset of the will; and add, in response to receiving a confirmation from the user, the person to a list of beneficiaries of the will, or the property to a list of assets of the will.

### BACKGROUND

Estate planning covers the transfer of property and assets after death. In complex situations, estate planning includes the guidance and counsel of several advisors. These advisors may include attorneys, accountants, financial planners, life insurance agents, bankers, brokers, and others. The primary document in estate planning is the will, which is a document that provides for the distribution of property at the time of death.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a diagram illustrating an operating environment, according to an embodiment;

FIG. 2 is a flow diagram illustrating control and data flow for identifying potential assets or beneficiaries to include in a will, according to an embodiment;

FIG. 3 is a flowchart illustrating a method for identifying trigger events, according to an embodiment;

FIG. 4 is a flowchart illustrating a method for assigning asset valuation, according to an embodiment;

FIG. 5 is an example user interface for managing elements of a will, according to an embodiment;

FIG. 6 is a flowchart illustrating a method for managing beneficiaries and assets of a will, according to an embodiment; and

FIG. 7 is a block diagram illustrating an example machine upon which any one or more of the techniques (e.g., methodologies) discussed herein may perform, according to an example embodiment.

### DETAILED DESCRIPTION

In the following description, for purposes of explanation, numerous specific details are set forth in order to provide a thorough understanding of some example embodiments. It will be evident, however, to one skilled in the art that the present disclosure may be practiced without these specific details.

Systems and methods described herein provide a digital estate planning system. Current processes for the creation and management of wills is manually resource intensive and complex, often requiring extensive offline communication between parties and inconvenient storage of paper documents. Furthermore, conventional processes are often individually isolated and therefore limited in their extendibility into other tangential areas, which may benefit the provision of information associated with a user's estate. As such, a digital will platform provides advantages, such as easier accessibility to users (e.g., will owner and selected designated parties such as family, friends, financial advisors, lawyers, etc.), more accurate inventory and valuation, and providing an auditable record of transactions. This document describes a digital platform to allow for efficient will drafting and estate planning management.

Systems and techniques described herein provide a digital will platform for the creation and management of a digital will by a will owner along with any designated parties. An easy user-friendly interface is used to update to the digital will in real-time, thereby providing an accurate will with up-to-date information. Authenticated users may interact with the digital will platform to allocate assets with particular beneficiaries using the user interface. A beneficiary pool may be associated with one or more beneficiaries. Authenticated users may also use the digital will platform to visualize or test various asset allocations to observe tax liabilities or other estate planning functions.

An authenticated user may upload various digital content to the digital will platform. The digital will platform may categorize and store the digital content in various ways. For example, if a user uploads a picture of a house, the digital will platform may allow the user to associate the digital content with a corresponding house asset. Alternatively, the digital will platform may use machine learning techniques (e.g., convolutional neural network) to identify and classify uploaded digital content and automatically select an asset with which to associate the digital content. The digital will platform may also manage and store digital media designated for post-mortem usage. For example, post-mortem designated digital media may include pre-recorded video messages to loved ones, files for associated memorial services (e.g., music, obituary, memorial slideshow, poems, memorial capsule, desired arrangements (flower types, preferred vendors, etc.)), and the like.

The digital will platform also provides asset inventory functions to identify possible assets, assign or allocate assets to beneficiaries, and track asset valuation. The assets may be determined using a backend asset engine configured to process associated transaction data associated with the digital will owner to identify potential assets. Additionally, or alternatively, an authenticated user may provide user input indicative of the one or more assets. Once allocated, an asset may be reallocated by authenticated users associated with designation permissions. As such, assets may be allocated and re-allocated in real-time.

Further, the digital will platform may include an asset valuation backend engine configured to process data associated with an asset in order to generate an estimated asset value for the asset. Data associated with the asset (e.g., asset manufacturer, year of manufacture, maintenance, etc.) may be input by the user or may be automatically determined based on transaction data. A valuation engine may be configured with one or more machine learning models (e.g., CNNs, recurrent neural networks (RNNs), etc.) to process the data associated with the asset to generate a valuation estimate for the asset.

Additionally, the digital will platform provides beneficiary functions to identify possible beneficiaries, assign beneficiaries to a beneficiary pool, and track value of gifts to a beneficiary or beneficiary pool. Possible beneficiaries may be determined using a backend beneficiary engine configured to process interactions between the digital will owner and other people or entities to identify possible beneficiaries. Additionally, or alternatively, an authenticated user may provide user input indicative of beneficiaries.

Further, the digital will platform may provide recommendations to authenticated users based on the current digital will. For example, if one or more assets are currently unallocated, the digital will platform may provide one or more prompts to the authenticated user to recommend the user allocate the unallocated assets and may provide the interaction interface required for the authenticated user to do so. The digital will service may also provide recommendations for additional services based on associated assets or asset valuation data, such as retirement account management, benefit assistance, etc. These functions and others are described in more detail below.

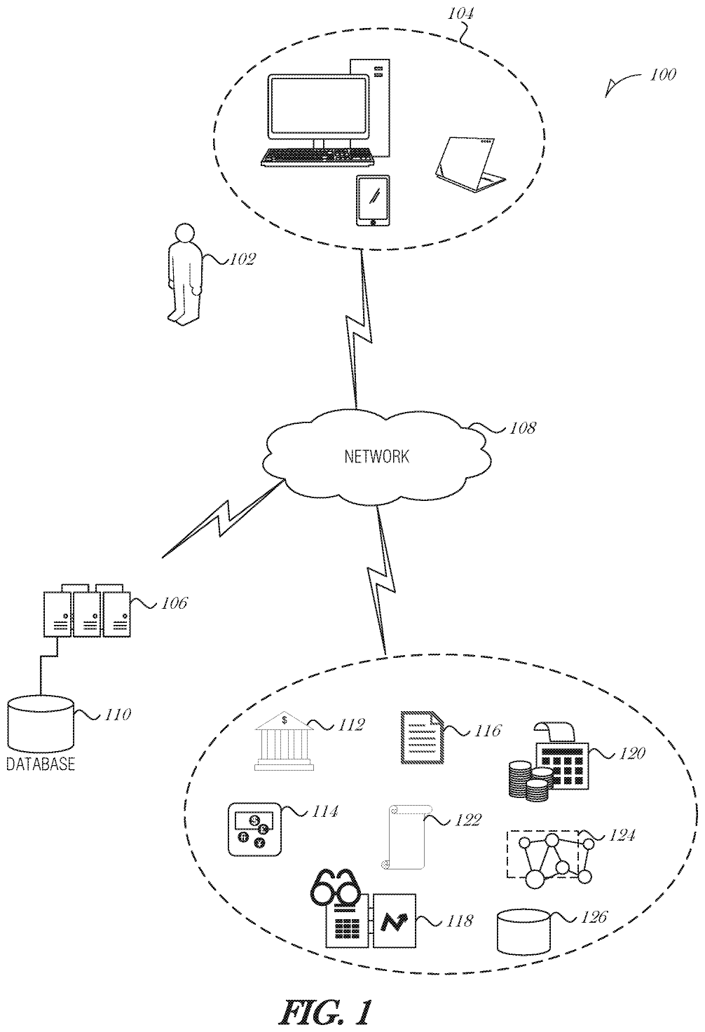

FIG. 1 is a diagram illustrating an operating environment 100, according to an embodiment. A user 102 may use a user device 104 to access an online system 106. The user device 104 may be of any type of form factor including, but not limited to a desktop computer, a mobile device, a laptop computer, a smartphone, a tablet device, a personal digital assistant, or the like.

The online system 106 may include various web servers, database servers, proxy devices, firewalls, storage devices, and network devices. The online system 106 may provide a web-based interface accessible via a uniform resource locator (URL). The online system 106 may provide various levels of security, such as requiring an account with a username and password, a secure channel (e.g., HTTPS), two-factor authentication, and the like.

To connect to the online system 106, the user 102 may execute an application (“app”) to connect via a network 108. In various examples, the servers and components in the operating environment 100 may communicate via one or more networks such as network 108. The network 108 may include one or more of local-area networks (LAN), wide-area networks (WAN), wireless networks (e.g., 802.11 or cellular network), the Public Switched Telephone Network (PSTN) network, ad hoc networks, cellular, personal area networks or peer-to-peer (e.g., Bluetooth®, Wi-Fi Direct), or other combinations or permutations of network protocols and network types. The network 108 may include a single local area network (LAN) or wide-area network (WAN), or combinations of LANs or WANs, such as the Internet.

Data used in online system 106 may be organized and stored in a variety of manners. For convenience, the organized collection of data is described herein as database 110. The specific storage layout and model used in database 110 may take a number of forms-indeed, database 110 may utilize multiple models. Database 110 may be, but is not limited to, a relational database (e.g., SQL), non-relational database (NoSQL) a flat file database, object model, document details model, or a file system hierarchy. The database 108 may store data on one or more storage devices (e.g., a hard disk, random access memory (RAM), etc.). The storage devices may be in standalone arrays, part of one or more servers, and may be located in one or more geographic areas.

A database management system (DBMS) may be used to access the data stored within database 110. The DBMS may offer options to search the database 110 using a query and then return data in the database 110 that meets the criteria in the query. For example, a SQL query may be utilized to retrieve all beneficiaries related to an estate planning document for a specific customer or another query may be used to retrieve all assets associated with a specific beneficiary. Another query may retrieve potential assets or beneficiaries as identified by processes described below. The DBMS may operate on one or more of the components of the online system 106.

The online system 106 provides an electronic estate planning and management platform. One function provided by the online service is to manage assets and beneficiaries of wills.

A will is a legal document that outlines the distribution or transfer of property at the time of death. In many jurisdictions, a will is required to be a written document, signed by the testator, and witnessed by at least two people. The testator is the person who is making the will. The will includes one or more bequests, which are provisions that leave property to a beneficiary. A beneficiary is someone who receives an inheritance though a will. Beneficiaries may be a natural person, a charity, a corporation or other legal entity, a trust, a pet, or the like.

In some jurisdictions, a personal property memorandum may be used to leave specific gifts. A will can reference a personal property memorandum and incorporate the gifts listed in the memorandum. The memorandum requires a signature of the decedent, but does not require a witness' signature. Personal property memorandums are used to gift tangible personal property, such as furniture, art, jewelry, and the like. However, personal property memorandums are not used for real estate or intangible personal property, such as money, stocks, bonds, or intellectual property. The systems and techniques described herein may be used to prepare and manage beneficiaries and assets for use in a personal property memorandum or similar document.

In addition to wills, which are executed after a person dies, the systems and techniques described herein may be used to manage beneficiaries and assets for gifts that are performed during the donor's life. Assets that are distributed while the donor is alive may reduce the size of the estate and may be tracked by the systems described herein. As such, the systems and techniques are useful to a person for asset management before and after death.

In operation, a user 102 may log into the online system 106 to access their account. The user 102 is able to create, modify, or delete elements of a will. The elements include assets, beneficiaries, and bequests. Assets include any property that is at least partially owned by the testator of the will. The user 102 may be the testator or another person who is authorized to make changes to the testator's will. The testator may assign people who are authorized to change the elements of the will in the online system 106, such as a trustee, parent, executor, one with power of attorney, etc. In some examples, the online system 106 is used to identify and organize assets, beneficiaries, and bequests, but does not act as an official will. In other examples, the online system 106 may generate a document that acts as a will. As such, the management of the elements of the will may be available to a broader group of people rather than just the testator themselves. In such a case where others are able to add, modify, or delete will elements, the testator may be required to print and sign a document to produce a will. This action provides the evidence of actual intent to incorporate any changes to the elements via the online system 106.

It is not uncommon to have to change or update a will. Many life events may cause the need to change a will such as a marital status change, a birth or death of a named or potential beneficiary, moving to a new location with different intestate laws, the acquisition or disposal of property, or the death of a named executor, or a change in tax laws, just to list a few examples. These life events may be detected by the online system 106 using systems and techniques described herein. In particular, the online system 106 is able to detect potential new beneficiaries or new assets by analyzing transactional histories of the user 102.

The online system 106 is connected to one or more other systems, which may include banking system 112, brokerage system 114, insurance system 116, credit bureau system 118, tax and revenue system 120, title and licensing system 122, social media system 124, and other sources 126. While some systems are illustrated in FIG. 1, it is understood that the online system 106 may be connected to any system that provides information about the user 102, including the user's property, user's assets, user's family or acquaintances, user's financial accounts, user's retail purchase history, user's credit rating or use, user's online or social media presence, or the like.

The banking system 112 may include various types of systems that support or provide financial services such as loans, savings accounts, checking accounts, debit accounts, and the like.

The brokerage system 114 may include various types of systems that support or provide financial services such as buying or selling stocks, mutual funds, bonds, options, and other securities.

The insurance system 116 may include various types of systems that support or provide services such as auto insurance, life insurance, property insurance, annuities, and the like.

The credit bureau system 118 may include various types of systems that support or provide financial services such as credit application processing, creditworthiness ratings, debt collection tracking, borrowing and bill-paying habits, and the like.

The tax and revenue system 120 may include various types of systems that support or provide services such as personal or business tax collections and refunds, and track revenues collected from taxes on income and profits, social security contributions, taxes levied on goods and services, and the like. The tax and revenue system 120 may be a regional system, such as a local, state, or federal system.

The title and licensing system 122 may include various types of systems that support or provide services to track ownership of personal or business property such as automobile licensing, driver's licenses, business permits and licenses, residential home titles, and the like.

The social media system 124 may include various types of systems that support or provide services to share photos, blog posts, meetings, stories, and the like, to the general public, a subscribed group, friends and family, or other audiences.

Other sources 126 may include newspapers, online search engines, online news outlets, and the like. For instance, a newspaper may publish a written obituary and also publish an online version of the obituary. As another example, an employer's website may publish an article celebrating the employee-decedent.

By interfacing with one or more of these systems 112-126, the online system 106 is able to gather a broad spectrum of information about the user 102 including past purchases or sales, intended or planned future purchases or sales, income and debt levels, occupation and social circles, family demographics, spending and saving trends, travel and interests, political and religious affiliations, and more. Using this information, the online system 106 is able to identify potential changes in assets or beneficiaries. After identifying these potential changes, the online system 106 may notify the user 102, update one or more elements of a will, update a will, or perform other operations as discussed herein.

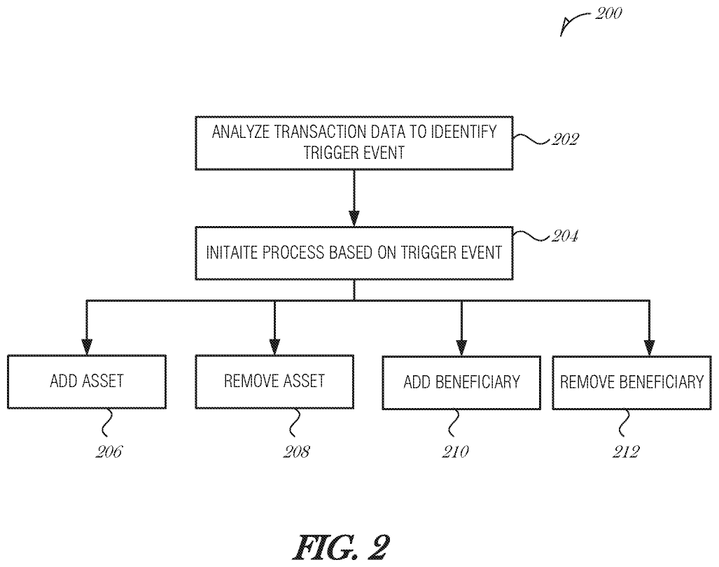

FIG. 2 is a flow diagram illustrating control and data flow 200 for identifying potential assets or beneficiaries to include in a will, according to an embodiment. At operation 202, transaction data from one or more data sources is analyzed to identify trigger events. The data source may include systems, such as a banking system 112, brokerage system 114, insurance system 116, credit bureau system 118, tax and revenue system 120, or title and licensing system 122 discussed in FIG. 1. The transaction data may be transaction data that has been aggregated, statistically analyzed, binned, or otherwise pre-processed. Alternatively, the transaction data may be raw transaction data from data sources. Transaction data may include data related to any type of transaction, such as financial transactions, which may include buying goods or services, selling property, posting for an asset for sale, searching for a rental property, donating to a charity, depositing money into an account, establishing an insurance policy, or the like; or social transactions, which may include establishing or terminating a relationship on a social media platform, posting a birth announcement, posting a photo of a wedding, or the like.

At operation 204, the triggering event is used to initiate one or more processes. The processes include adding an asset to a will (process 206), removing an asset from a will (process 208), adding a beneficiary to a will (process 210), or removing a beneficiary from a will (process 212). Operations 202 and 204 may be implemented in various ways, such as with a trained machine learning model, conditional programming, directed graphs, decision making systems, or the like.

Process 206, adding an asset to a will, may include operations such as 1) identifying and naming the potential asset, 2) notifying a will owner of the potential asset to confirm that the asset should be added to the will, and 3) adding the asset to a list of assets associated with the will. The notification may be performed using an electronic notification (e.g., email, text message, pop up user interface element, etc.). The confirmation may also be performed using electronic means, such as with a user interface interaction. The electronic means for notification and confirmation may be via an electronic estate management platform, such as online system 106 from FIG. 1. Notification and confirmation may also be performed via post office mail, physical documents, or other mechanisms.

Additionally, process 206 may include the computational operations of adding an asset record to a database and associating the record with one or more other records to indicate the relationship between the asset record and the one or more other records, where the other records may be records for people (e.g., beneficiaries), assets (e.g., for a pool of assets), valuation (e.g., to determine or track valuation of the asset), ownership (e.g., to identify a share of ownership that the will owner has in the asset), or other data regarding the asset. An asset record may include an asset identifier (ID), an asset name, an asset description, an asset type, an asset valuation, an asset pool identifier (foreign ID for an asset pool), a beneficiary identifier (foreign ID for a beneficiary or beneficiary pool), and other information about the asset.

Process 208, removing an asset from a will, may include operations such as 1) receiving an asset identifier, 2) notifying a will owner of the asset to confirm that the asset should be removed from the will, and 3) removing the asset from a list of assets associated with the will, along with removing any relationships between the asset and beneficiaries or other assets. As with the process for adding an asset 206, the notification may be performed using an electronic notification (e.g., email, text message, pop up user interface element, etc.). The confirmation may also be performed using electronic means, such as with a user interface interaction. The electronic means for notification and confirmation may be via an electronic estate management platform, such as online system 106 from FIG. 1. Notification and confirmation may also be performed via post office mail, physical documents, or other mechanisms.

Additionally, process 208 may include the computational operations of removing or deactivating an asset record from a database and removing association of the record with one or more other records. To deactivate the asset, the attribute may be changed from a logical TRUE to a logical FALSE. Maintaining the asset record after disposal or sale of the real world property may be useful, such as in a case where the asset may be re-purchased or recovered (e.g., after recovery from theft or loss). Assets may also be deactivated after they are distributed, such as when a donor gives away an asset before death. Such transactions are captured and maintained for others' reference, for instance to determine which donees were granted which gifts.

Process 210, adding a beneficiary to a will, may include operations such as 1) identifying and naming the potential beneficiary, 2) notifying a will owner of the potential beneficiary to confirm that the beneficiary should be added to the will, and 3) adding the beneficiary to a list of beneficiary associated with the will. The notification may be performed using an electronic notification (e.g., email, text message, pop up user interface element, etc.). The confirmation may also be performed using electronic means, such as with a user interface interaction. The electronic means for notification and confirmation may be via an electronic estate management platform, such as online system 106 from FIG. 1. Notification and confirmation may also be performed via post office mail, physical documents, or other mechanisms.

Additionally, process 210 may include the computational operations of adding a beneficiary record to a database and associating the record with one or more other records to indicate the relationship between the beneficiary record and the one or more other records, where the other records may be records for people (e.g., beneficiaries), assets (e.g., for a pool of assets), or personal information (e.g., home address, phone number, email address, etc.). A beneficiary record may include a beneficiary identifier (ID), a beneficiary name, a beneficiary description, a beneficiary type, and other information about the beneficiary.

Process 212, removing a beneficiary from a will, may include operations such as 1) receiving a beneficiary identifier, 2) notifying a will owner of the beneficiary to confirm that the beneficiary should be removed from the will, and 3) removing the beneficiary from a list of beneficiaries associated with the will, along with removing any relationships between the beneficiary and assets or other beneficiaries. As with the process for adding a beneficiary 210, the notification may be performed using an electronic notification (e.g., email, text message, pop up user interface element, etc.). The confirmation may also be performed using electronic means, such as with a user interface interaction. The electronic means for notification and confirmation may be via an electronic estate management platform, such as online system 106 from FIG. 1. Notification and confirmation may also be performed via post office mail, physical documents, or other mechanisms.

Additionally, process 212 may include the computational operations of removing or deactivating a beneficiary record from a database and removing association of the record with one or more other records. The beneficiary record may include an attribute indicating whether the beneficiary is active or not. To deactivate the beneficiary, the attribute may be changed from a logical TRUE to a logical FALSE. Maintaining the beneficiary record after removing the beneficiary may be useful, such as in a case where the beneficiary is temporarily out of favor with the will owner.

Asset records and beneficiary records may be related to one another using one or more join tables. Join tables are used as an intermediate table to relate rows (records) in one table to rows (records) in another table. Relationships between assets and beneficiaries may be included in join tables to store related beneficiaries (e.g., a beneficiary pool may include two or more beneficiaries that have been bequeathed the same asset), related assets (e.g., an asset pool may include two or more assets that have been grouped together for an aggregate gift), or the like. For instance, a beneficiary pool table may include a beneficiary pool identifier and one or more beneficiary identifiers (foreign ID for a beneficiary) in a one-to-many relationship. Similarly, an asset pool table may include an asset pool identifier and one or more asset identifiers (foreign ID for an asset). A bequest table may include one or more beneficiary identifiers and one or more asset identifiers, or beneficiary pool identifiers or asset pool identifiers, in a many-to-many relationship. It is understood that other data structures and data models may be used.

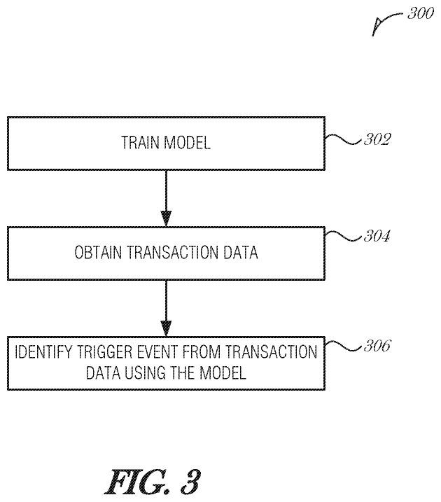

FIG. 3 is a flowchart illustrating a method 300 for identifying trigger events, according to an embodiment. At 302, a model is trained based on transaction data. The model may be specific to detect or infer assets or beneficiaries from the transaction data.

At 304, transaction data is obtained from one or more sources. The transaction data may of any type of data, such as a bank statement, a real-time stock feed from a brokerage firm, a quarterly summary from a credit card issuer, or the like.

At 306, the transaction data is used with the model to identify a trigger event. Trigger events may be classified into various categories, such as “potential asset acquisition”, “potential asset disposition”, “potential addition of beneficiary”, or “potential removal of beneficiary”.

For example, the model may be trained to parse natural language or standardized formats of a bank statement to identify a payment to an automobile dealership for a vehicle, which may indicate a vehicle purchase. The vehicle model, trim, buyer or owner, and other details such as purchase price or tax base, may be obtained from title information. Based on this information, a trigger event indicating a potential asset purchase may be created through the method 300.

As another example, the model may be trained to parse and interpret credit bureau reports. The model may identify a new account that was opened. The account may be for a car loan, a boat loan, or the like. Based on this information, a trigger event indicating a potential asset purchase may be created through the method 300.

As another example, the model may be trained to parse and interpret electronic images of checks drafted from a checking account. The model may identify a payee (or recipient) of a check and a subject matter of the check (e.g., from the memo line of the check). Perhaps the check is to a niece as a wedding gift. Based on this information, a trigger event indicating a potential addition of a beneficiary may be created through the method 300. The potential beneficiary may be the niece or a member of the niece's new family.

As another example, the model may be trained to parse and interpret account statements from several different accounts. The model may identify a relationship between two people based on a transaction history (e.g., allowance paid to a child), shared addresses, shared accounts, account access history, or the like. The related user may be a potential beneficiary.

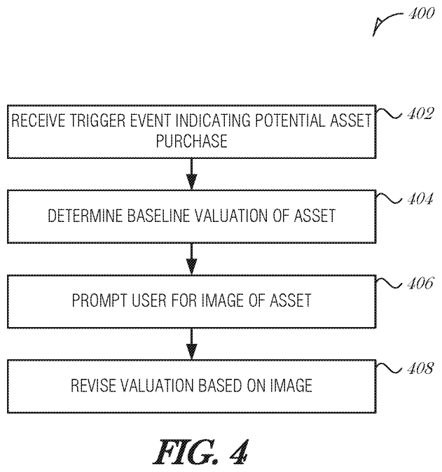

FIG. 4 is a flowchart illustrating a method 400 for assigning asset valuation, according to an embodiment. At 402, a trigger event indicating a potential asset purchase is received.

At 404, a baseline valuation is determined. The baseline valuation may be based on a manufacturer's suggested retail price (MSRP), a standard valuation (e.g., a Bluebook value), a purchase price, or the like.

At 406, a user is prompted for an image of the asset. The user may be working within a graphical user interface (GUI) on an estate planning online system, such as online system 106. The user may upload an image file that is saved on the user's computer, for instance.

At 408, the baseline valuation is revised based on the image. Image analysis may provide hints on the condition, size, amount, or other features of an asset. The valuation is revised and stored in a data store, such as database 110 in online system 106.

Attributes of the image may be used as part of the valuation update. For instance, an image of an asset taken over a year ago is not necessarily representative of the asset's current condition. As such, the timestamp of the image, location of where the image was taken, and other attributes of the image (e.g., focus, detail, lighting, etc.) may be used to vary the amount of weight an image may have on a valuation adjustment.

Images may be used periodically (e.g., requested annually) to update the valuation. An image-based valuation may be adjusted as time continues. For instance, a vehicle may have a Bluebook value of $5000. One or more images are provided that shows the interior and exterior of the vehicle are in excellent condition. As such, the image-based valuation is increased by 10% to $5500. Over time, the valuation is reduced at some rate consistent with the type of asset. Here, the vehicle may be depreciated on a progressive scale of 20% after the first year, 15% per year for the next four years, and then 10% per year for the remaining years in service. The make, model, type, and other factors may be used to adjust the depreciation function. Further, it is understood that assets may appreciate in value, or appreciate or depreciate at different amounts or for specific reasons.

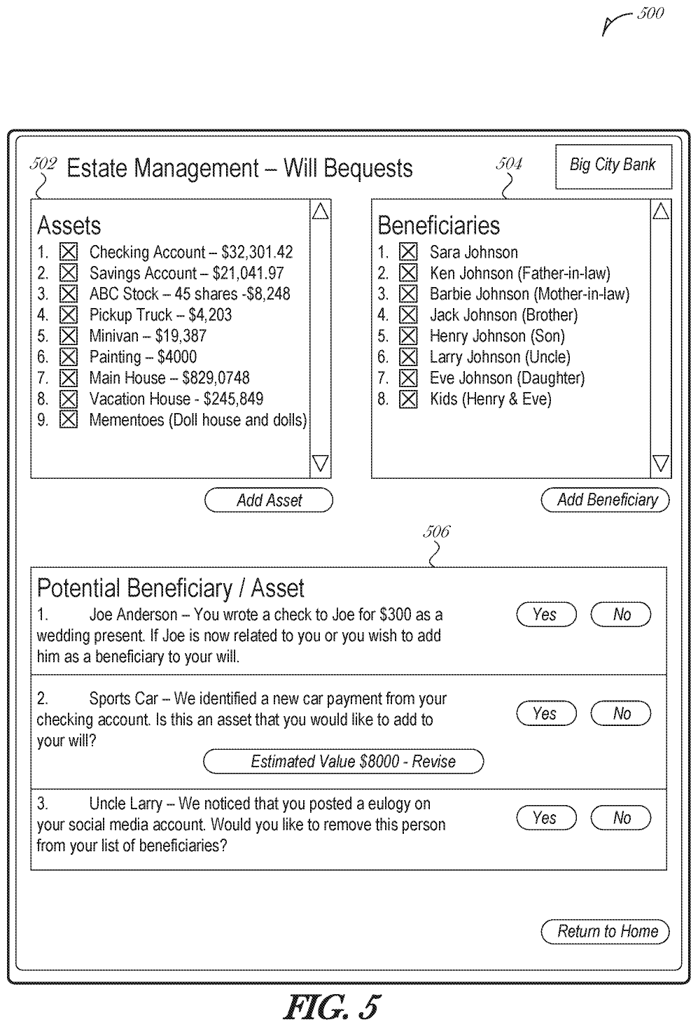

FIG. 5 is an example user interface 500 for managing elements of a will, according to an embodiment. The user interface 500 is designed to allow a user to manage elements of a will including assets 502 and beneficiaries 504. A user is provided views of all of the assets 502 and beneficiaries 504 and user interface controls to add or delete them. A different user interface (not shown) may be used to manage relationships between assets 502 and beneficiaries 504, expressing bequeaths.

The user interface 500 includes a notification area 506 with one or more potential changes to the list of assets 502 or beneficiaries 504. In the example illustrated in FIG. 5, a new potential beneficiary is identified as “Joe Anderson” based on transaction data. The transaction data includes a check that was cleared where Joe was a payee and the memo line in the check indicated that was a wedding gift. The user is provided user interface controls to accept and add this potential beneficiary to the beneficiary list 504 or dismiss this suggested beneficiary.

Similarly, a potential new asset was discovered and presented as “Sports Car.” A debit from a checking account was identified as possibly being a car payment and the “Sports Car” asset was associated with the car payment using other transaction data obtained from a state registration database. An initial valuation was calculated based on the tax base of the vehicle and the payment. The user is provided an opportunity to revise the valuation for the purposes of asset tracking in the estate planning system. If the user decides to revise the estimate value of this asset, the user may activate the user interface control and be prompted for one or more images to upload to assist the system in calculating a more accurate valuation.

Based on a social media post transaction, an existing beneficiary “Uncle Larry” is identified as possibly having passed recently. The user is asked for confirmation and if this beneficiary has died, the user may remove him from the list of beneficiaries 504 and remove relationships with any assets (e.g., planned gifts to the beneficiary).

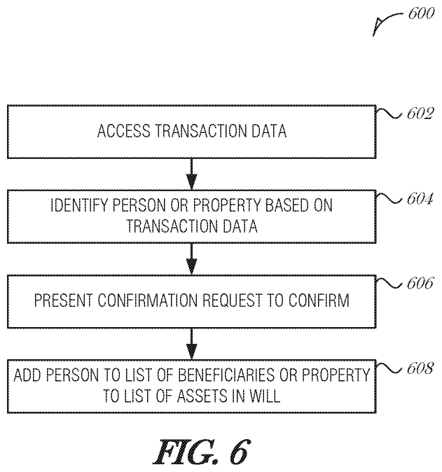

FIG. 6 is a flowchart illustrating a method 600 for managing beneficiaries and assets of a will, according to an embodiment. The method 600 may be performed by an electronic system (e.g., online system 106) or any of the modules, logic, circuits, processors, or components described herein.

At 602, accessing transaction data related to a user is accessed. In an embodiment, the transaction data includes bank account data, insurance account data, credit bureau data, tax data, property title data, or social media data.

At 604, a person or a property is identified based on the transaction data. In an embodiment, identifying the person based on the transaction data includes determining a payee of a financial transaction (where the user is a payor of the financial transaction) and identifying the payee of the financial transaction as the person. In a further embodiment, the method 600 includes determining a subject matter of the financial transaction and identifying the payee of the financial transaction as the person based on both the payee and the subject matter.

In an embodiment, identifying the property based on the transaction data includes determining a subject matter of a financial transaction (where the user is a payor of the financial transaction) and identifying the subject of the financial transaction as the property. In a further embodiment, the financial transaction includes a loan application. In another embodiment, the financial transaction includes a loan payment.

At 606, a confirmation request is presented to the user to confirm that the person is a beneficiary of the will or that the property is an asset of the will. In an embodiment, presenting the confirmation request includes transmitting a text message to a user device of the user. In a related embodiment, presenting the confirmation request includes transmitting an email to a user device of the user. In a related embodiment, presenting the confirmation request includes presenting a user interface element in a web page on a user device of the user.

At 608, in response to receiving a confirmation from the user, the person is added to a list of beneficiaries of the will, or the is added property to a list of assets of the will.

Embodiments may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

A processor subsystem may be used to execute the instruction on the machine-readable medium. The processor subsystem may include one or more processors, each with one or more cores. Additionally, the processor subsystem may be disposed on one or more physical devices. The processor subsystem may include one or more specialized processors, such as a graphics processing unit (GPU), a digital signal processor (DSP), a field programmable gate array (FPGA), or a fixed function processor.

Examples, as described herein, may include, or may operate on, logic or a number of components, modules, or mechanisms. Modules may be hardware, software, or firmware communicatively coupled to one or more processors in order to carry out the operations described herein. Modules may be hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

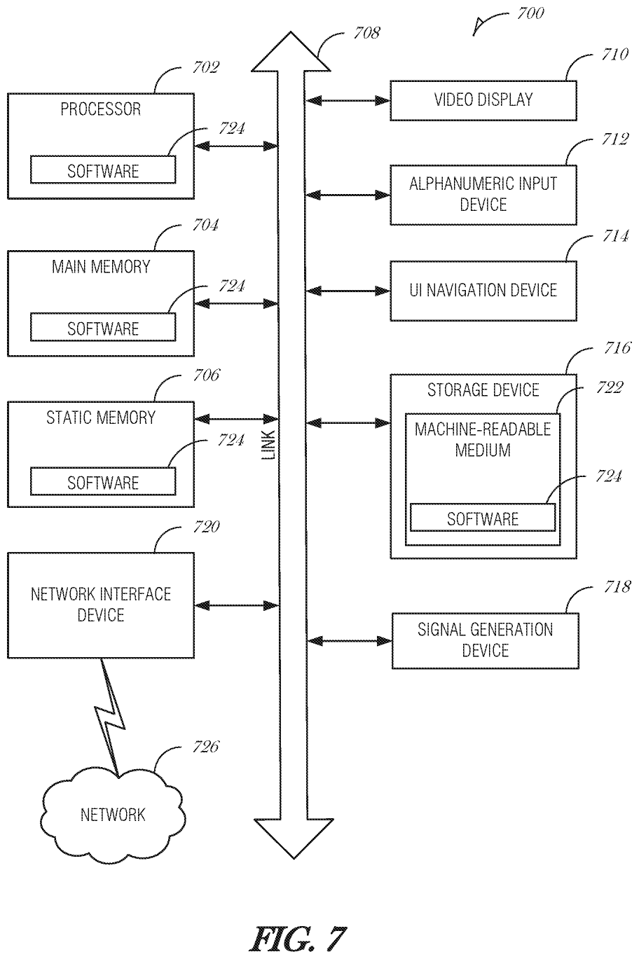

FIG. 7 is a block diagram illustrating a machine in the example form of a computer system 700, within which a set or sequence of instructions may be executed to cause the machine to perform any one of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be an onboard vehicle system, set-top box, wearable device, personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 700 includes at least one processor 702 (e.g., a central processing unit (CPU), a graphics processing unit (GPU) or both, processor cores, compute nodes, etc.), a main memory 704 and a static memory 706, which communicate with each other via a link 708 (e.g., bus). The computer system 700 may further include a video display unit 710, an alphanumeric input device 712 (e.g., a keyboard), and a user interface (UI) navigation device 714 (e.g., a mouse). In one embodiment, the video display unit 710, input device 712 and UI navigation device 714 are incorporated into a touch screen display. The computer system 700 may additionally include a storage device 716 (e.g., a drive unit), a signal generation device 718 (e.g., a speaker), a network interface device 720, and one or more sensors (not shown), such as a global positioning system (GPS) sensor, compass, accelerometer, or other sensor.

The storage device 716 includes a machine-readable medium 722 on which is stored one or more sets of data structures and instructions 724 (e.g., software) embodying or utilized by any one or more of the methodologies or functions described herein. The instructions 724 may also reside, completely or at least partially, within the main memory 704, static memory 706, and/or within the processor 702 during execution thereof by the computer system 700, with the main memory 704, static memory 706, and the processor 702 also constituting machine-readable media.

While the machine-readable medium 722 is illustrated in an example embodiment to be a single medium, the term “machine-readable medium” may include a single medium or multiple media (e.g., a centralized or distributed database, and/or associated caches and servers) that store the one or more instructions 724. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 724 may further be transmitted or received over a communications network 726 using a transmission medium via the network interface device 720 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi, 3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

### Additional Notes & Examples

Example 1 is an online system for managing beneficiaries and assets of a will, the online system comprising: memory including instructions, which when executed by the processor subsystem, cause the processor subsystem to: access transaction data related to a user; identify a person or a property based on the transaction data; present a confirmation request to the user to confirm that the person is a beneficiary of the will or that the property is an asset of the will; and add, in response to receiving a confirmation from the user, the person to a list of beneficiaries of the will, or the property to a list of assets of the will.

In Example 2, the subject matter of Example 1 includes, wherein the transaction data includes bank account data, insurance account data, credit bureau data, tax data, property title data, or social media data.

In Example 3, the subject matter of Examples 1-2 includes, wherein to identify the person based on the transaction data, the processor subsystem is to: determine a payee of a financial transaction, wherein the user is a payor of the financial transaction; and identify the payee of the financial transaction as the person.

In Example 4, the subject matter of Example 3 includes, wherein the processor subsystem is to: determine a subject matter of the financial transaction; and identify the payee of the financial transaction as the person based on both the payee and the subject matter.

In Example 5, the subject matter of Examples 1-4 includes, wherein to identify the property based on the transaction data, the processor subsystem is to: determine a subject matter of a financial transaction, wherein the user is a payor of the financial transaction; and identify the subject of the financial transaction as the property.

In Example 6, the subject matter of Example 5 includes, wherein the financial transaction includes a loan application.

In Example 7, the subject matter of Examples 5-6 includes, wherein the financial transaction includes a loan payment.

In Example 8, the subject matter of Examples 1-7 includes, wherein to present the confirmation request, the processor subsystem is to: transmit a text message to a user device of the user.

In Example 9, the subject matter of Examples 1-8 includes, wherein to present the confirmation request, the processor subsystem is to: transmit an email to a user device of the user.

In Example 10, the subject matter of Examples 1-9 includes, wherein to present the confirmation request, the processor subsystem is to: present a user interface element in a web page on a user device of the user.

Example 11 is a method for managing beneficiaries and assets of a will, the method performed on an electronic online system, the method comprising: accessing, by the electronic online system, transaction data related to a user; identifying, using the electronic online system, a person or a property based on the transaction data; presenting, using the electronic online system, a confirmation request to the user to confirm that the person is a beneficiary of the will or that the property is an asset of the will; and adding, by the electronic online system, in response to receiving a confirmation from the user, the person to a list of beneficiaries of the will, or the property to a list of assets of the will.

In Example 12, the subject matter of Example 11 includes, wherein the transaction data includes bank account data, insurance account data, credit bureau data, tax data, property title data, or social media data.

In Example 13, the subject matter of Examples 11-12 includes, wherein identifying the person based on the transaction data comprises: determining a payee of a financial transaction, wherein the user is a payor of the financial transaction; and identifying the payee of the financial transaction as the person.

In Example 14, the subject matter of Example 13 includes, determining a subject matter of the financial transaction; and identifying the payee of the financial transaction as the person based on both the payee and the subject matter.

In Example 15, the subject matter of Examples 11-14 includes, wherein identifying the property based on the transaction data comprises: determining a subject matter of a financial transaction, wherein the user is a payor of the financial transaction; and identifying the subject of the financial transaction as the property.

In Example 16, the subject matter of Example 15 includes, wherein the financial transaction includes a loan application.

In Example 17, the subject matter of Examples 15-16 includes, wherein the financial transaction includes a loan payment.

In Example 18, the subject matter of Examples 11-17 includes, wherein presenting the confirmation request comprises: transmitting a text message to a user device of the user.

In Example 19, the subject matter of Examples 11-18 includes, wherein presenting the confirmation request comprises: transmitting an email to a user device of the user.

In Example 20, the subject matter of Examples 11-19 includes, wherein presenting the confirmation request comprises: presenting a user interface element in a web page on a user device of the user.

Example 21 is a machine-readable medium comprising instructions for managing beneficiaries and assets of a will, which when executed by a machine, cause the machine to: access transaction data related to a user; identify a person or a property based on the transaction data; present a confirmation request to the user to confirm that the person is a beneficiary of the will or that the property is an asset of the will; and add, in response to receiving a confirmation from the user, the person to a list of beneficiaries of the will, or the property to a list of assets of the will.

In Example 22, the subject matter of Example 21 includes, wherein the transaction data includes bank account data, insurance account data, credit bureau data, tax data, property title data, or social media data.

In Example 23, the subject matter of Examples 21-22 includes, wherein to identify the person based on the transaction data, the instructions cause the machine to: determine a payee of a financial transaction, wherein the user is a payor of the financial transaction; and identify the payee of the financial transaction as the person.

In Example 24, the subject matter of Example 23 includes, wherein the instructions cause the machine to: determine a subject matter of the financial transaction; and identify the payee of the financial transaction as the person based on both the payee and the subject matter.

In Example 25, the subject matter of Examples 21-24 includes, wherein to identify the property based on the transaction data, the instructions cause the machine to: determine a subject matter of a financial transaction, wherein the user is a payor of the financial transaction; and identify the subject of the financial transaction as the property.

In Example 26, the subject matter of Example 25 includes, wherein the financial transaction includes a loan application.

In Example 27, the subject matter of Examples 25-26 includes, wherein the financial transaction includes a loan payment.

In Example 28, the subject matter of Examples 21-27 includes, wherein to present the confirmation request, the instructions cause the machine to: transmit a text message to a user device of the user.

In Example 29, the subject matter of Examples 21-28 includes, wherein to present the confirmation request, the instructions cause the machine to: transmit an email to a user device of the user.

In Example 30, the subject matter of Examples 21-29 includes, wherein to present the confirmation request, the instructions cause the machine to: present a user interface element in a web page on a user device of the user.

Example 31 is at least one machine-readable medium including instructions that, when executed by processing circuitry, cause the processing circuitry to perform operations to implement of any of Examples 1-30.

Example 32 is an apparatus comprising means to implement of any of Examples 1-30.

Example 33 is a system to implement of any of Examples 1-30.

Example 34 is a method to implement of any of Examples 1-30.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described.

However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

1. An online system for managing beneficiaries and assets of a will, the online system comprising:
a processor subsystem; and
memory including instructions, which when executed by the processor subsystem, cause the processor subsystem to:
access transaction data related to a user;
access a trained machine-learning model that is trained using data from account statements from financial accounts to infer relationships between people based on transaction histories found in the account statements;
use the transaction data as input to the trained machine-learning model to identify a potential beneficiary based on an inference of relationship with the user;
present a confirmation request to the user to confirm that the potential beneficiary is to be added to the will; and
add, in response to receiving a confirmation from the user, the potential beneficiary to a list of beneficiaries of the will.

2. The online system of claim 1, wherein the transaction data includes bank account data, insurance account data, credit bureau data, tax data, property title data, or social media data.

3.-4. (canceled)

5. (canceled)

6.-7. (canceled)

8. The online system of claim 1, wherein to present the confirmation request, the processor subsystem is to: transmit a text message to a user device of the user.

9. The online system of claim 1, wherein to present the confirmation request, the processor subsystem is to: transmit an email to a user device of the user.

10. The online system of claim 1, wherein to present the confirmation request, the processor subsystem is to: present a user interface element in a web page on a user device of the user.

11. A method for managing beneficiaries and assets of a will, the method performed on an electronic online system, the method comprising:
accessing, by the electronic online system, transaction data related to a user;
accessing, by the electronic online system, a trained machine-learning model that is trained using data from account statements from financial accounts to infer relationships between people based on transaction histories found in the account statements;
using, by the electronic online system, the transaction data as input to the trained machine-learning model to identify a potential beneficiary based on an inference of relationship with the user;
presenting, using the electronic online system, a confirmation request to the user to confirm that the potential beneficiary is to be added to the will; and
adding, by the electronic online system, in response to receiving a confirmation from the user, the potential beneficiary to a list of beneficiaries of the will.

12. The method of claim 11, wherein the transaction data includes bank account data, insurance account data, credit bureau data, tax data, property title data, or social media data.

13.-14. (canceled)

15. (canceled)

16.-17. (canceled)

18. A non-transitory machine-readable medium comprising instructions for managing beneficiaries and assets of a will, which when executed by a machine, cause the machine to:
access transaction data related to a user;
access a trained machine-learning model that is trained using data from account statements from financial accounts to infer relationships between people based on transaction histories found in the account statements;
using the transaction data as input to the trained machine-learning model to identify a potential beneficiary based on an inference of relationship with the user;
present a confirmation request to the user to confirm that the potential beneficiary is to be added to the will; and
add, in response to receiving a confirmation from the user, the potential beneficiary to a list of beneficiaries of the will.

19. The machine-readable medium of claim 18, wherein the transaction data includes bank account data, insurance account data, credit bureau data, tax data, property title data, or social media data.

20. (canceled)
